(19) United States
(12) Patent Application Publication
(10) Pub. No.: US 2012/0054460 A1
(43) Pub. Date: Mar. 1, 2012

(54) METHOD AND SYSTEM FOR STORAGE SYSTEM MIGRATION

(75) Inventors: Qiao Qing Dai, Shanghai (CN); Min Fang, Shanghai (CN); Hui Xiang Gu, Shanghai (CN); Zhen Quan Zhu, Shanghai (CN)

(73) Assignee: Internatinal Business Machines Corporation, Armonk, NY (US)

(21) Appl. No.: 13/217,739

(22) Filed: Aug. 25, 2011

(30) Foreign Application Priority Data
Aug. 31, 2010 (CN) 201010271164.X

(51) Int. Cl. G06F 12/02

(52) U.S. Cl. 711/165; 711/E12.002

(57) ABSTRACT

A method, migration manager, and system of storage system migration. The method includes creating a first zone including a host system in a first SAN-based storage system and an in-band SAN virtualization storage node. The method creates a second zone including a backend storage system in the first SAN-based storage system and the in-band SAN virtualization storage node. A storage unit exported by the backend storage system is mapped to a virtual storage unit created on the in-band SAN virtualization storage node, and a third zone including the host system and backend storage system in the first SAN-based storage system is canceled. The method is performed without disrupting an existing connection path between the host system and the backend storage system in the first SAN-based storage system. A migration manager of a migration system migrates a first SAN-based storage system into an in-band SAN virtualization storage system.

### CROSS-REFERENCE TO RELATED APPLICATIONS

This application claims priority under 35 U.S.C. §119 from Chinese Patent Application No. 201010271164.X filed Aug. 31, 2010, the entire contents of which are incorporated herein by reference.

### BACKGROUND OF THE INVENTION

1. Field of the Invention

The present invention relates to storage area networks (SAN), and particularly, to a method and system for storage system migration. And more particularly, the method and system can migrate a conventional SAN-based storage system to an In-Band SAN virtualization storage system.

2. Description of Related Art

A storage area network (SAN) is a kind of architecture for connecting remote storage devices to a host system, such that for an operating system on the host system, the remote storage devices look like a locally connected storage devices. At the communication layer, a SAN usually uses the SCSI protocol to perform communications between the host system and the storage devices, while at the physical layer, a SAN usually uses an FC fabric consisting of a number of fiber channel (FC) switches to perform communications among the devices. For a SAN including many storage devices and host systems, the FC fabric is usually divided into a plurality of zones, and the host system in each of the zones can only access the storage devices in the zone, and cannot access the storage devices in other zones.

A conventional SAN-based storage system includes a host system, an FC switch network and a backend storage system, wherein the host system and the backend storage system belong to the same zone, and thus the host system can access the backend storage system by the FC switch network. Herein, such a conventional SAN-based storage system is also called a first SAN-based storage system.

Different from the conventional SAN-based storage system are in-band SAN virtualization storage systems. An in-band SAN virtualization storage node is provided in the data transmission path between the host and storage devices in the SAN. The in-band SAN virtualization storage node virtualizes the storage devices from the backend storage system into virtual storage devices and provides the virtual storage devices to the host system. In the in-band SAN virtualization storage system, the in-band SAN virtualization storage node and the host system are in one zone, while the in-band SAN virtualization storage node and the backend storage system are in another zone. Different from the conventional SAN-based storage system, the host system and the backend storage system are not included in the same zone, thus the host and the backend storage system cannot communicate directly, and have to communicate through the in-band SAN virtualization storage node.

The in-band SAN virtualization storage system is more and more widely applied because it has better application responsiveness, maximized storage utilization, dynamic resource allocation, improved storage management and reduced storage interruptions. Thus, more and more enterprises are migrating a conventional SAN-based storage system into an in-band SAN virtualization storage system.

For migrating a conventional SAN-based storage system into an in-band SAN virtualization storage system, the existing solution includes the following steps:

1) In the host system, stop running the host application that performs IO operations on storage units in the backend system.

2) Delete the original zone configuration including the host system and the backend storage system, so as to disconnect the original connection path between the host system and the backend storage system.

3) Create a zone configuration including the host system and the in-band SAN virtualization storage node.

4) Create a zone configuration including the in-band SAN virtualization storage node and the backend storage system.

5) Map the storage units exported by the backend storage system into the virtual storage units created by the in-band SAN virtualization storage system, and maintain the block-to-block correspondence relationship between the storage units and the virtual storage units.

6) Restart the host application.

The disadvantage of the above solution is that before the original storage system is migrated into the in-band SAN virtualization storage system, the user has to stop his application. Stopping an existing, running application can be unacceptable for high end users.

### SUMMARY OF THE INVENTION

In one aspect of the present invention, there is provided a method of storage system migration for migrating a first SAN-based storage system into an in-band SAN virtualization storage system. The method operates without disrupting an existing connection path between a host system and a backend storage system in the first SAN-based storage system. The method creates a first zone configuration including the host system in the first SAN-based storage system and an in-band SAN virtualization storage node in the in-band SAN virtualization storage system. The method also creates a second zone configuration including the backend storage system in the first SAN-based storage system and the in-band SAN virtualization storage node. The method maps a storage unit exported by the backend storage system to a virtual storage unit created on the in-band SAN virtualization storage node, and cancels a third zone configuration including the host system and backend storage system in the first SAN-based storage system.

In another aspect of the present invention, there is provided a system for storage system migration for migrating a first SAN-based storage system into an in-band SAN virtualization storage system without disrupting an existing connection path between the host system and the backend storage system in the first SAN-based storage system. The system includes a means for creating a first zone configuration including the host system in the first SAN-based storage system and an in-band SAN virtualization storage node in the in-band SAN virtualization storage system. The system also includes a means for creating a second zone configuration including the backend storage system in the first SAN-based storage system and the in-band SAN virtualization storage node. In addition, the system has means for mapping a storage unit exported by the backend storage system to a virtual storage unit created on the in-band SAN virtualization storage node, and means for canceling a third zone configuration including the host system and backend storage system in the first SAN-based storage system.

In yet another aspect of the present invention, there is provided a migration manager of a storage system for making a zone management module in an FC switch to migrate a first SAN-based storage system into an in-band SAN virtualization storage system without disrupting an existing connection path between the host system and the backend storage system in the first SAN-based storage system. The migration manager includes means for creating a first zone configuration including the host system in the first SAN-based storage system and the in-band SAN virtualization storage node in an in-band SAN virtualization storage system. The manager also has means for creating a second zone configuration including the backend storage system in the first SAN-based storage system and the in-band SAN virtualization storage nodeIn the in-band SAN virtualization storage node, a storage unit exported by the backend storage system is mapped to a virtual storage unit created on the in-band SAN virtualization storage node. Further, the manager includes means for making the zone management module in the FC switch to cancel a third zone configuration including the host system and backend storage system in the first SAN-based storage system.

The advantages of the present invention include: a conventional SAN-based storage system can be migrated into an in-band SAN virtualization storage system seamlessly, that is to say, the migration can be carried out without interrupting the existing host applications, so that users' needs are better met. Furthermore, in some embodiments of the present invention, the whole migration process can be performed automatically.

### BRIEF DESCRIPTION OF THE DRAWINGS

The characteristics of the present invention which are considered as novel features are described in the appended claims. However, the invention itself and its preferred embodiments, other objectives and advantages can be better understood by referring to the following detailed description of exemplary embodiments when read in conjunction with the accompanying drawings, in which:

FIG. 1 illustrates an example of a first SAN-based storage system on which an embodiment of the method of the present invention can be applied;

FIG. 2 illustrates an example of an in-band SAN virtualization storage system formed by applying an embodiment of the method of the present invention;

FIG. 3 illustrates a method of migrating a first SAN-based storage system into an in-band SAN virtual storage system according to an embodiment of the present invention;

FIG. 4 illustrates a schematic diagram of a plurality of paths from the host system to the storage units in the backend storage system formed in the migration process according to an embodiment of the present invention;

FIG. 5 illustrates a schematic diagram of a single path from the host system to the storage units in the backend storage system through an in-band SAN virtualization storage node formed during the migration process according to an embodiment of the present invention; and

FIG. 6 illustrates a migration manager for migrating a first SAN-based storage system into an in-band SAN virtualization storage system and the relationships between the migration manager and other related devices in the migration process according to an embodiment of the present invention.

### DETAILED DESCRIPTION OF THE PREFERRED EMBODIMENTS

The present invention provides a method and system for migrating a first SAN-based storage system into an in-band SAM virtualization storage system, which can guarantee that the IO processes in the existing storage system will not be terminated during the migration process, i.e., a host application will not have to be stopped.

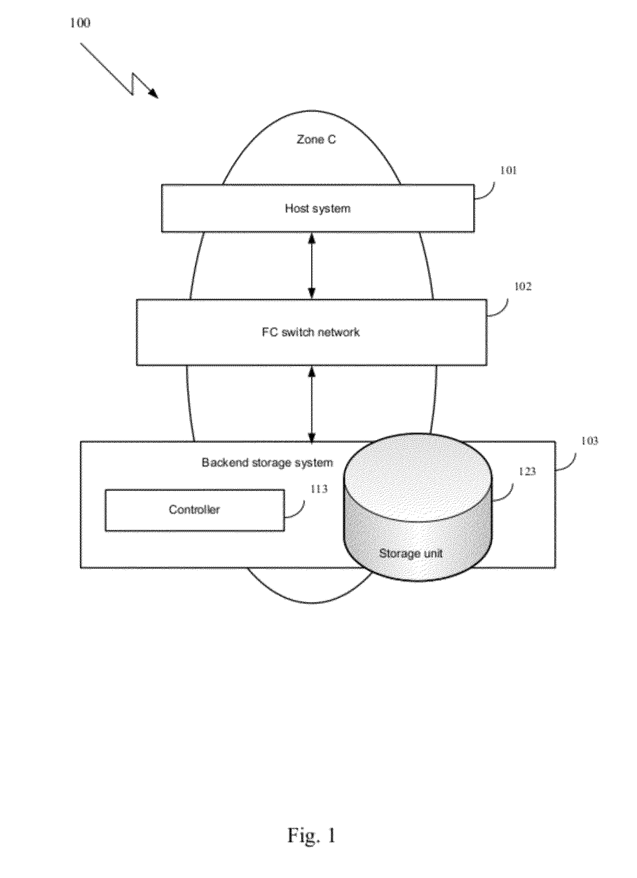

FIG. 1 illustrates an example of a first SAN-based storage system on which the method of the present invention can be applied. As shown, the first SAN-based storage system 100 includes one or more host systems 101, an FC switch network 102, and one or more backend storage systems 103, wherein the host systems 101 and the backend storage system are in the same Zone C. There can be one or more host systems 101, and each host system 101 is a computer system having an FC interface connecting to the FC switch network 102, and generates storage operation requests to the backend storage systems 103. The FC switch network 102 is one or more switches connected in a switch topology. There can be one or more backend storage systems 103, and each backend storage system 103 includes one or more storage controllers 113 and one or more storage units 123, receives IO requests to the storage units 123, and includes a group of FC interfaces connecting to the FC switch network. The storage unit 123 includes mediums for storing data, e.g., SAS disks, SSDs, CDs, etc. In an SAN, each storage unit 123 is assigned a logic unit number (LUN) as a unique identification of the storage unit 123 in the SAN. In an embodiment of the present invention, the storage controller 113 can be various storage controllers such as IBM DS 4 k/5 k/6 k/8 k, EMC Symmetrix and CLARiiON, HP EVA, HDS storage, etc.

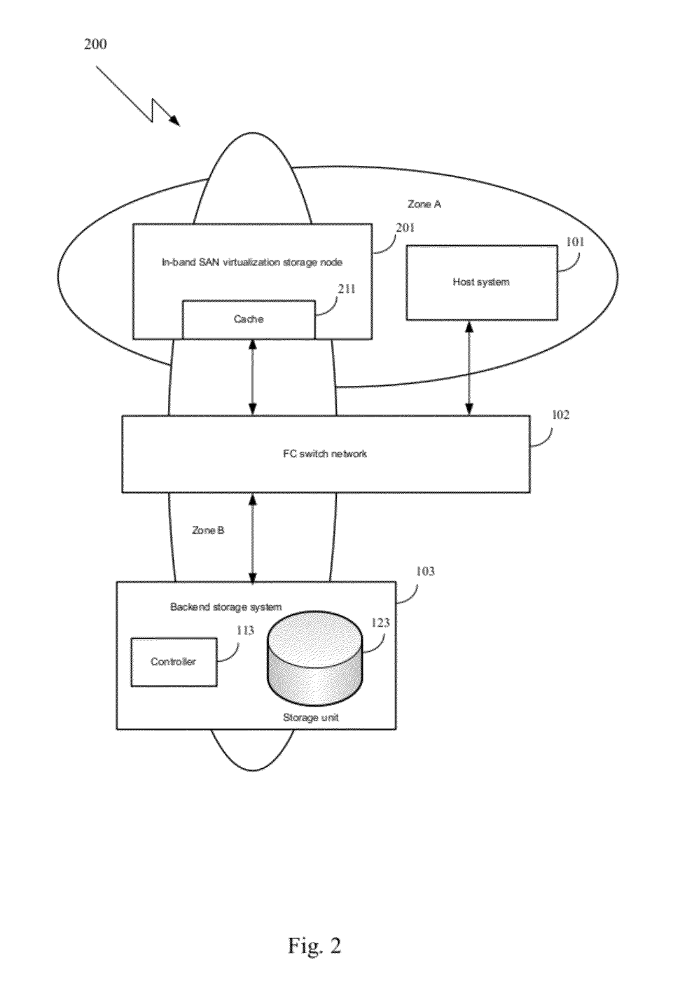

FIG. 2 illustrates an example of the in-band SAN virtualization storage system formed by applying the method according to an embodiment of the present invention. As shown, the in-band SAN virtualization storage system 200 includes a host system 101, an in-band SAN virtualization storage node 201, an FC switch network 102, and a backend storage system 103. The host system 101 and the in-band SAN virtualization storage node 201 are included in Zone A, and the in-band SAN virtualization storage node 201 and backend storage system 103 are included in Zone B. Different from the first SAN-based storage system 100, the host system 101 and backend storage system 103 are not included in the same zone. Thus, the storage units in the backend storage system 103 are only visible to the in-band SAN virtualization storage node 201, but not to the host system 101; the host system 101 can only access the storage units in the backend storage system 103 through the in-band SAN virtualization storage node 201, and cannot access the storage units in the backend storage system 103 directly. The in-band SAN virtualization storage node 201 can further include a cache 211 for caching I/O read and write data from and to the backend storage system, so as to improve the data access performance.

The in-band SAN virtualization storage node 201 can be a set of X Series servers running Linux, which provide the SAN virtualization function so as to virtualize different backend storage systems 103 into a single storage pool, and takes over the IO requests generated by the host system 101 to the backend storage system 103. In the in-band SAN virtualization storage system 200, the IO requests must be transmitted to the in-band SAN virtualization storage node 201, and then transmitted to the backend storage systems 103 by the in-band SAN virtualization storage node 201, but are not directly transmitted to the backend storage system 103. There can be one or more in-band SAN virtualization storage nodes 201, and preferably more, so that the usability of the system is improved, and the access performance is increased by dispersing requests for various storage units.

Migrating a first SAN-based storage system 100 into an in-band SAN virtualization storage system 200 can be implemented by either method herein described. In a first method, migrating a first SAN-based storage system 100 into an in-band SAN virtualization storage system 200 is implemented by adding a new in-band SAN virtualization storage node 201 to a first SAN-based storage system 100 and applying the method of the present invention on the first SAN-based storage system 100 and the newly added in-band SAN virtualization storage node 201. In a second method, migrating a first SAN-based storage system 100 into an in-band SAN virtualization storage system 200 is implemented by adding a first SAN-based storage system 100 to an existing in-band SAN virtualization storage system 200 and at the same time applying the method of the present invention. In the second method, the existing in-band SAN virtualization storage system 200 already includes an in-band SAN virtualization storage node 201, a set of host systems 100, a set of backend storage systems 103 and an FC switch network 102.

Hereinafter, embodiments of the present invention will be described by referring to the accompanying drawings. In the following description, numerous details are set forth for a comprehensive understanding of the present invention. However, it is obvious to those skilled in the art that the implementation of the present invention can exclude some of these details. Furthermore, it should be appreciated that the present invention is not limited to the described specific embodiments. Rather, it is considered that any arbitrary combination of the following features and elements can be used to implement the present invention, whether they relate to different embodiments or not. Therefore, the following aspects, features, embodiments and advantages are only used for illustration, rather than elements or limitation to the appended claims, unless explicitly stated otherwise in the claims.

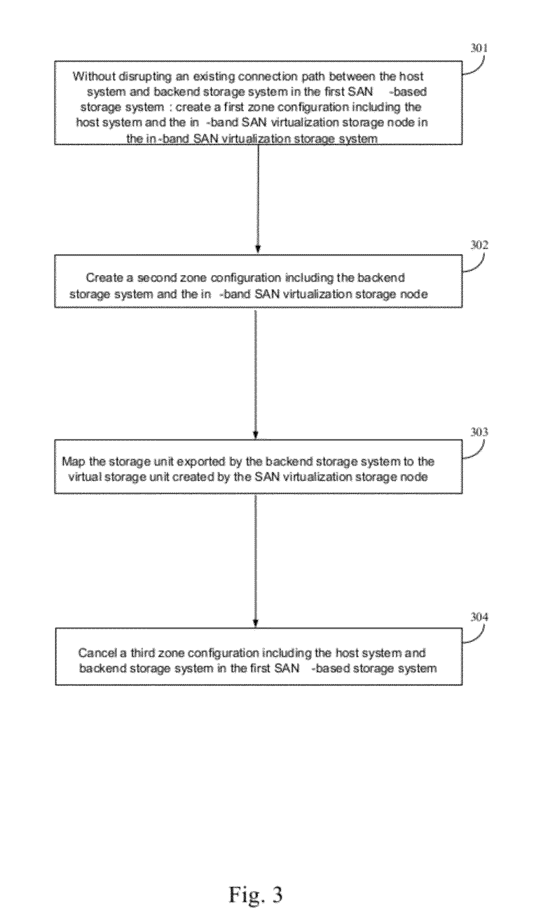

FIG. 3 illustrates a method of storage system migration according to an embodiment of the present invention, which is used to migrate a first SAN-based storage system into an in-band SAN virtualization storage system. As shown, the method includes the following steps:

At step 301, without disconnecting the original connection path between the host system 101 and the backend storage system 103 in a first SAN-based storage system 100, a first zone configuration including the host system 101 in the first SAN-based storage system 100 and the in-band SAN virtualization storage node 201 in the in-band SAN virtualization storage system is created. That is to say, the host system 101 in the first SAN-based storage system 100 and the in-band SAN virtualization storage node 201 are configured into the same one zone. For the case where the in-band SAN virtualization storage system 200 is formed by adding a new in-band SAN virtualization storage node 201 to a first SAN-based storage system 100, this means a new zone including the host system 101 and the newly added in-band SAN virtualization storage node 201 is created. For the case where the first SAN-based storage system 100 is added to the existing in-band SAN virtualization storage system 200, this means either a new zone including the added host system 101 and the existing in-band SAN virtualization storage node 201 is created, or the added host system 101 is added to an existing zone including the existed in-band SAN virtualization storage node 201 and other host systems 101.

As known by those skilled in the art, a zone defines which ports of the FC switches in the SAN can communicate with each other. Therefore, the process of creating a zone or zone configuration refers to setting the ports that need to access each other in one zone by the zone management software in the FC switches.

In one embodiment of the present invention, the process of the method of the present invention is controlled by a migration manager, which can be provided on a dedicated migration management host system, or on other host systems 101 in SAN. The migration manager communicates with the host system 101, FC switches 102, in-band SAN virtualization storage node 201 through Ethernet (which can include one or a set of Ethernet switches), to send relevant commands for migration to them. In the host system 101 and the in-band SAN virtualization storage node 201 are provided respective agents which have Ethernet interfaces, so as to receive relevant commands from the migration manager, and forward the relevant commands to the relevant modules in the host system 101 and the in-band SAN virtualization storage node 201 to perform corresponding operations. The FC switch 102 also has an Ethernet interface, which can receive commands from the migration manager and forward the received commands to the zone management software in the FC switch 102 to perform corresponding zone setting operations. For example, in an embodiment of the present invention, a command for creating a zone or zone configuration is transmitted to the FC switch 102 in the SAN through the Ethernet by the migration manager, and the zone management software in the FC switch will create the corresponding zone or zone configuration according to the command.

At step 302, a second zone configuration including the backend storage system 103 in the first SAN-based storage system 100 and the in-band SAN virtualization storage node 201 is created. That is to say, the backend storage system 103 in the first SAN-based storage system 100 and the in-band SAN virtualization storage node 201 are configured into the same one zone. For details about the process of creating the second zone configuration, refer to the above description of the process of creating the first zone configuration.

At step 303, the storage units exported by the backend storage system 103 in the first SAN-based storage system 100 are mapped to the virtual storage units created by the in-band SAN virtualization storage node 201.

As known by those skilled in the art, a Fiber Channel Host Bus Adapter (FC HBA) is installed on the in-band SAN virtualization storage node 201, and the FC HBA is connected to the FC switch network 102. When the backend storage system 103 in the first SAN-based storage system 100 and the in-band SAN virtualization storage node 201 are configured into the same zone, the FC switch network 102 will detect that a new fiber communication device is added to the zone where the in-band SAN virtualization storage node 201 is located and automatically complete the FC protocol negotiation process, including mutual discovery, login and connection creation among all the ports in the zone. After the process is completed, the FC HBA installed on the in-band SAN virtualization storage node 201 will discover the creation of a new connection. Thus, the in-band SAN virtualization storage node 201 can perform the discovery of SCSI devices by the new connection, so as to discover the storage units included in the backend storage system 103 and relevant information thereof. Specifically, the in-band SAN virtualization storage node 201 can transmit SCSI commands, such as INQUIRY, READ CAPACITY, through the SCSI protocol stack and by all the newly created connections, to read the device information (e.g., identification (UID), capacity (CAPACITY) etc.) of the storage units in the newly added backend storage system 103. According to the acquired information, the in-band SAN virtualization storage node 201 will create corresponding virtual storage units which will have the same identifications and capacities as the storage units in the discovered backend storage system 103.

The in-band SAN virtualization storage node 201 further stores the information of the created virtual storage units in a virtual storage unit table. The virtual storage unit table will have the following columns: storage unit identification, capacity and a connection (or connection path) for accessing the real storage unit. In this way, it is realized that the storage units exported by the backend storage system 103 are mapped to the virtual storage units created by the in-band virtual storage node 201. Thus, when the in-band SAN virtualization storage node 201 receives an IO request from the host system 101, a corresponding connection can be obtained by querying the virtual storage unit table according to the identification of the virtual storage unit contained in the IO request, so as to transmit the IO request to the corresponding storage unit in the backend storage system 103 through the connection. Furthermore, during this process, the logic block address (LBA) of the IO request remains unchanged. That is to say, the in-band SAN virtualization storage node 201 will transmit the IO request for a specific block address in the virtual storage unit to the corresponding storage unit in the backend storage system 103 as an IO request for the same block address in the corresponding storage unit in the backend storage system 103. Thus, it is guaranteed that, through the in-band SAN virtualization storage node 201, the IO request from the host system 101 can still access the same data in the storage unit of the backend storage system 103, which were directly accessed originally.

In an embodiment of the present invention, an agent is provided in the in-band SAN virtualization storage node 201, and the agent has an Ethernet interface to communicate with the migration manager described above through the Ethernet. In this embodiment, after the backend storage system 103 in the first SAN-based storage system 100 and the in-band SAN virtualization storage node 201 are configured into the same zone, the in-band SAN virtualization storage node 201 does not automatically discover the newly connected SCSI device (i.e., the newly added backend storage system and the storage units thereof), rather the migration manager transmits a command for discovering the newly connected SCSI device to the agent provided in the in-band SAN virtualization storage node 201; and after receiving the command, the agent informs a corresponding module (e.g., FC HBA) in the in-band SAN virtualization storage node 201 to discover the newly connected SCSI device. In this way, the in-band SAN virtualization storage node 201 is enabled to discover the storage units in the newly connected backend storage system 103 more timely, more quickly, and more assuredly, and the communication traffic and bandwidth usage in the discovering process are saved.

After the storage units exported by the backend storage system 103 in the first SAN-based storage system 100 are mapped to the virtual storage units created by the in-band SAN virtualization storage node 201, because the in-band SAN virtualization storage node 201 and the host system 101 are in the same zone, the FC switch network 102 can automatically create a connection between the host system 101 and the in-band SAN virtualization storage node 201 by the FC protocol negotiation process. Additionally, the host system 101 can further perform the discovery of SCSI devices through the connection, so as to discover the virtual storage units exported by the in-band SAN virtualization storage node 201 and the relevant information thereof, such as the storage unit identifications and capacities of the virtual storage units.

Since the virtual storage unit has the same storage unit identification as the storage unit exported by the backend storage system 103, at this time there is a plurality of paths from the host system 101 to the same storage unit exported by the backend storage system 103. One of the plurality of paths is the original path from the host system 101 to the storage unit in the backend storage system 103. Another path is a newly generated path from the host system 101 to the same storage unit in the backend storage unit 103 through the in-band SAN virtualization storage node 201.

Support by the multi-path software (such as, sdd, sddpcm, powerpath, etc.) installed in the host system 101, the IO request generated by the host system 101 can be transmitted to the storage unit in the backend storage system 103 either through the original path, or through the newly generated path via the in-band SAN virtualization storage node 201. If the multi-path software continues to use the original path to transmit 10 requests to the storage unit in the backend storage system 103, the multi-path software will use the newly generated path via the in-band SAN virtualization storage node 201 as a failover standby path. In this case, if the original path from the host system 101 to the storage unit in the backend storage system 103 temporarily fails, then the newly generated path via the in-band SAN virtualization storage node 201 will be selected to transmit the IO request for the storage unit in the backend storage system 103. Thus, new write data will be stored in the cache of the in-band SAN virtualization storage node 201. If the failure of the original path is subsequently cleared, the original path will be selected again by failback. Thus, the data in the cache of the in-band SAN virtualization storage node 201 can become outdated data, therefore resulting in data inconsistency.

Similarly, if the multi-path software selects the newly generated path via the in-band SAN virtualization storage node 201 to transmit the new IO requests and uses the original path as a failover standby path, new write data will be stored in the cache of the in-band SAN virtualization storage node 201. Thus, when the newly generated path fails, the original path will be selected to transmit the IO requests to the storage unit of the backend storage system 103, the data in the cache of the in-band SAN virtualization storage node 201 will become outdated data, therefore also resulting in data inconsistency.

In an embodiment of the present invention, to guarantee data consistency, an additional optional step is performed, at which the cache of the in-band SAN virtualization storage node 201 is disabled. In an embodiment of the present invention, the step can be performed by sending, by the migration manager, a command for disabling the cache to an agent provided in the in-band SAN virtualization storage node 201, and disabling the cache of the in-band SAN virtualization storage node 201 by the agent according to the command. Of course, the cache can also be disabled by an administrator through a management interface in the in-band SAN virtualization storage node 201. In some cases where the requirement for data consistency is not high, the additional optional step can be excluded.

In an embodiment of the present invention, optionally, the virtual storage units are mapped to the host system 101 by the in-band SAN virtualization storage node 201. This is carried out by creating a mapping table between the virtual storage units and the host system 101 in the in-band SAN virtualization storage node 201. In this way, a specific host system 101 can only access the designated virtual storage units, thus providing an additional privilege control mechanism besides the zone mechanism of the FC network.

At another additional optional step, the multi-path software in the host system 101 is informed to set a preferred connection path for transmitting IO requests for the storage units in the backend storage system 103. In an embodiment of the present invention, a command for discovering the virtual storage unit and setting the corresponding connection path is transmitted by the migration manager to the agent provided in the host system 101, and the identification of the newly created virtual storage unit in the in-band SAN virtualization storage node 201 (i.e., the identification of the corresponding storage unit in the backend storage system 103) can be transmitted in the command. After receiving the command, the agent provided in the host system 101 transmits the command to the multi-path software in the host system 101, and the multi-path software performs the discovery of SCSI devices according the command and the identification of the storage unit included therein, wherein SCSI commands are transmitted through all the newly discovered connections, so as to discover the virtual storage unit exported by the in-band SAN virtualization storage node 201. If the identification of the discovered virtual storage unit exported by the in-band SAN virtualization storage node 201 is the same as the identification transmitted in the command, the multi-path software can set the connection to the in-band SAN virtualization storage node 201 as a preferred connection path for transmitting the IO requests for the virtual storage unit (i.e., the corresponding storage unit in the backend storage system 103), and set the original connection to the backend storage system 103 as a failover standby path; or on the contrary, set the original connection to the backend storage system 103 as a preferred path, and set the connection to the in-band SAN virtualization storage node 201 as a failover standby path. In this way, the multi-path software in the host system 101 can discover the virtual storage units exported by the in-band SAN virtualization storage node 201 and set the preferred path and failover standby path for transmitting IO requests for specific storage units more timely, more quickly, and more assuredly, and save the communication traffic and bandwidth usage during the discovery process.

After the multi-path software in the host system 101 has set the preferred path and failover standby path for transmitting IO requests for the storage units in the backend storage system 103, the new IO requests for the storage units in the backend storage system 103 generated by the application in the host system 101 are transmitted through the preferred path, and when the preferred path fails, the failover standby path is enabled.

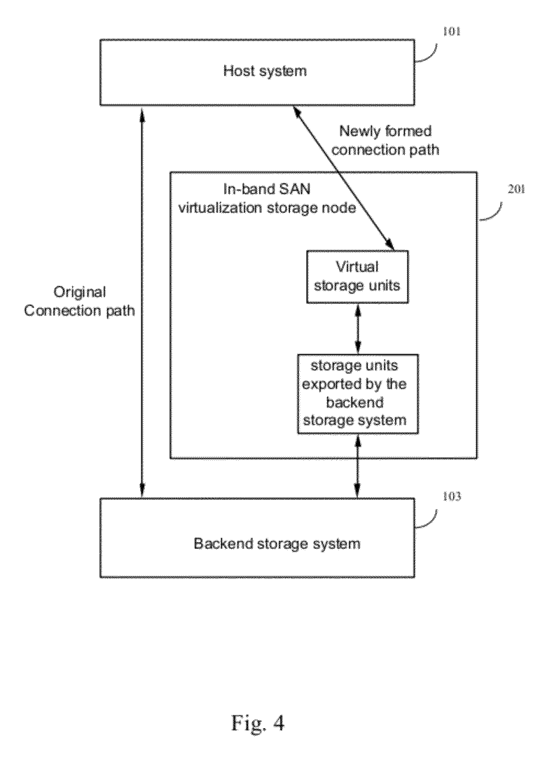

FIG. 4 illustrates a schematic diagram of a plurality of paths in the in-band SAN virtualization storage system formed after the above steps are performed. As shown, there are two connection paths between the host system 101 and the backend storage system 103, one connection path is the original connection path from the host system 101 to the backend storage system 103 (via an FC switch network not shown), and the other connection path is a newly formed connection path from the host system 101 to the backend storage system 103 through the in-band SAN virtualization storage node 201 (and an FC switch network not shown). Thus, IO requests from the host system 101 can be transmitted to the backend storage system 103 through any of the two paths. In the in-band SAN virtualization storage node 201, there is mapping relationships from the virtual storage units to the backend storage units.

In an embodiment of the present invention, the multi-path software in the host system 101 sets the connection path passing the in-band SAN virtualization storage node 201 as a preferred path, through which the new IO requests for the storage units in the backend storage system 103 generated by the host system 101 will be transmitted. By preferably using the new connection path passing the in-band SAN virtualization storage node 201 to transmit IO requests, the reliability and stability of the new connection path can be verified and the original connection path can be enabled when the new connection path fails. After running for a period of time, after the reliability and stability of the new connection path passing the in-band SAN virtualization storage node 201 has been verified, the original connection path can be disconnected. Of course, the original connection path can also be canceled immediately upon setting up the new connection path. Thus, the additional optional step of informing the multi-path software in the host system 101 to set a preferred connection path for sending IO requests for the storage units in the backend storage system 103 will be no longer required.

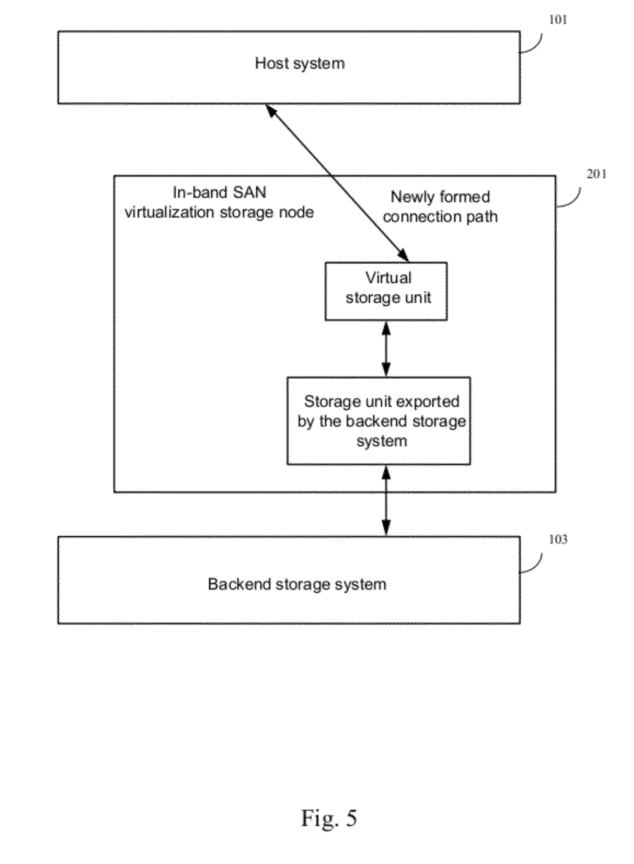

At step 304, the zone configuration including the host system 101 and the backend storage system 103 included in the first SAN-based storage system 100 is cancelled, so as to disconnect the connection path between the host system and the backend storage system 103, and keep the single newly generated path from the host system 101 to the backend storage system 103 through the in-band SAN virtualization storage node 201. FIG. 5 illustrates a schematic diagram of the single newly generated path from the host system 101 to the backend storage system 103 through the in-band SAN virtualization storage node 201 formed after the above steps are performed. Since this step is performed after the above steps are completed, it is guaranteed that the original connection path between the host system 101 and the backend storage system 103 does not need to be interrupted during the process of migrating the first SAN-based storage system 100 into the in-band SAN virtualization storage system 200, thus the application in the host system 101 does not need to be stopped, so that a seamless migration from the first SAN-based storage system 100 to in-band SAN virtualization storage system 200 is realized.

In the embodiment of the present invention including disabling the cache of the in-band SAN virtualization storage node 201, the method of migrating the first SAN-based storage system to the in-band SAN virtual storage system further includes an additional optional step, at which the cache in the in-band SAN virtualization storage node 201 is enabled. In an embodiment of the present invent, this step can be performed by transmitting a command for enabling the cache by the migration manager to the agent provided in the in-band SAN virtualization storage node 201 through the Ethernet and enabling the cache mode of the in-band SAN virtualization storage node 201 by the agent according to the command. Of course, the cache mode can also be enabled by the administrator through a management interface of the in-band SAN virtualization storage node 201.

Preferably, the above steps are performed by executing commands from a migration manager by the zone management module provided in the FC switch, the agent provided in the in-band SAN virtualization storage node 201, and the agent provided in the host system 101. And preferably, the migration manager transmits the relevant commands through the Ethernet, so as to provide out-band migration management.

Above is described a method of migrating a first SAN-based storage system 100 into an in-band SAN virtualization storage system 200 according to embodiments of the present invention by referring to the accompanying drawings. It should be pointed out that, the above description is only exemplary, and not limitation to the present invention. In other embodiments of the present invention, the method can have more, less or different steps, and the relationships between the steps can be different from that is described. For example, some of the above steps, e.g., step 301 and 302 can have different order or can be performed in parallel. For further example, some of the above steps are optional.

Hereinafter, a storage system migration manager of the present invention is described by referring the accompanying drawings. The storage system migration manager is for making a zone management module in a FC switch to migrate a first SAN-based storage system into an in-band SAN virtualization storage system 200 without disrupting the existing connection path between the host system in the first SAN-based storage system and back-end storage system.

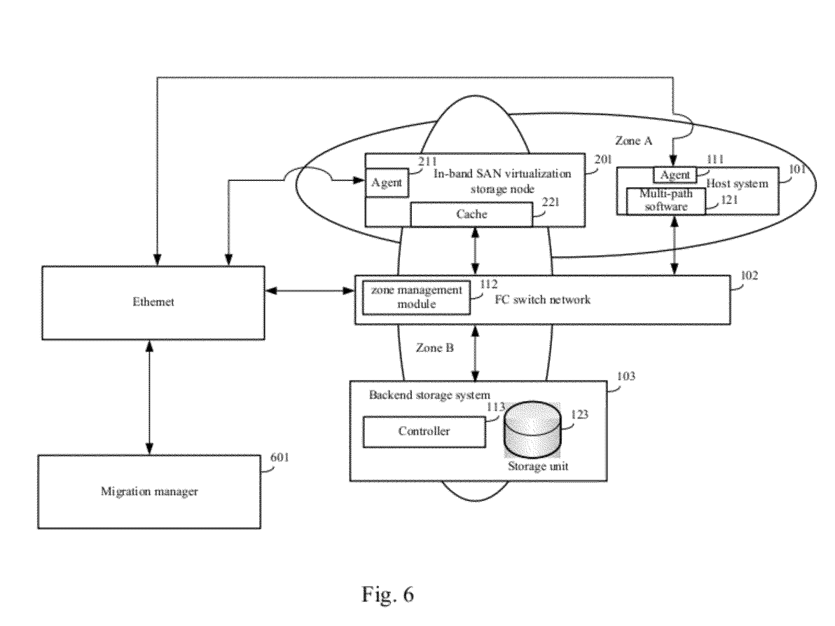

FIG. 6 illustrates a migration manager 601 for migrating a first SAN-based storage system 100 into an in-band SAN virtualization storage system 200 and the relationships between it and other related devices during the migration process according to an embodiment of the present invention. As shown, the migration manager 601 is connected to the FC switch network 102, the in-band SAN virtualization storage node 201 and the host system 101 through an Ethernet. The migration manager 601 transmits relevant commands to the zone management module 112 in the FC switch network 102, the agent 211 provided in the in-band SAN virtualization storage node 201 and the agent 111 provided in the host system 101 through the Ethernet, to make them to perform the relevant operations during the migration process.

According to an embodiment of the present invention, the migration manager 601 includes a means for, by transmitting a command to the zone management module in the FC switch network 102 of the first SAN-based storage system 100, making the zone management module in the FC switch network 102 create a first zone configuration including the host system 101 in the first SAN-based storage system 100 and the in-band SAN virtualization storage node 201 in the in-band SAN virtualization storage system. The means also creates a second zone configuration including the backend storage system 103 in the first SAN-based storage system and the in-band SAN virtualization storage node 201. Zone configurations are performed without disrupting the existing connection path between the host system 100 and the backend storage system 103 in the first SAN-based storage system 100 (i.e., the connection path between the host system 101 and the backend storage system 103 in the first SAN-bases storage system 100 that has already existed). The migration manager also provides, in the in-band SAN virtualization storage node 201, for mapping the storage units exported by the backend storage system 103 to the virtual storage units created on the in-band SAN virtualization storage node 201. After the above operations are completed, the migration manager further includes means for, by transmitting commands to the zone management module 112 in the FC switch network 102 of the first SAN-based storage system, making the zone management module 112 in the FC switch network 102 cancel a third zone configuration including the host system 101 and the backend storage system 103 in the first SAN-based storage system 100.

According to an embodiment of the present invention, after mapping the storage units exported by the backend storage system 103 to the virtual storage units created on the in-band SAN virtualization storage node 201, the migration manager 601 further includes means for, making the agent 211 disable the cache 221 of the in-band SAN virtualization storage node 201. The migration manager can disable the cache 221 by transmitting a command to the agent 211 in the in-band SAN virtualization storage node 201.

According to an embodiment of the present invention, after canceling the third zone configuration including the host system 101 and backend storage system 103 in the first SAN-based storage system 100, the migration manager 601 further includes means for, making the agent 211 enable the cache of the in-band SAN virtualization node 201. The migration manager can enable the cache by transmitting a command to the agent 211 in the in-band SAN virtualization node 201.

According to an embodiment of the present invention, after mapping the storage units exported by the backend storage system 103 to the virtual storage units created on the in-band SAN virtualization storage node 201, the migration manager 601 further includes means for, enabling the agent 111 to inform the multi-path software 121 in the host system 101 to set a preferred path for transmitting IO requests for the storage units in the backend storage system 103. The migration manager can enable the agent 111 by transmitting a command to the agent 111 on the host system 101.

According to an embodiment of the present invention, the command has an identification of the virtual storage unit to which the storage unit on the backend storage system corresponds. The command makes the agent 111 inform the multi-path software 121 on the host system 101 about the identification of the virtual storage unit. By doing so, the multi-path software 121 on the host system 101 can discover the connection path to the virtual storage node according to the identification of the virtual storage unit, and set the discovered connection path to the virtual storage unit as a preferred path for transmitting the IO requests for the corresponding storage units in the backend storage system 103.

According to an embodiment of the present invention, the virtual storage unit created on the in-band SAN virtualization storage node 201 has the same identification and capacity as the storage unit exported by the backend storage system 103.

According to an embodiment of the present invention, the virtual storage units created on the in-band SAN virtualization storage node 201 are mapped to the host system 101.

Hereinafter is described a storage system migration system according an embodiment of the present invention, for migrating a first SAN-based storage system into an in-band SAN virtualization storage system 200 without disrupting the existing connection path between the host system and the backend storage system in the first SAN-based storage system. In an embodiment of the present invention, the system is implemented by the migration manager 601, the zone management module 112 in the FC switch network 102, the agent 211 in the in-band SAN virtualization storage node 201, the agent 111, and multi-path software 121 in the host system 101 shown in FIG. 6.

According to an embodiment of the present invention, the system includes means for creating a first zone configuration including the host system 101 in the first SAN-based storage system 100 and the in-band SAN virtualization storage node 201 in the in-band SAN virtualization storage system. The system includes means for creating a second zone configuration including the backend storage system 103 in the first SAN-based storage system 100 and the in-band SAN virtualization storage node 201. The system includes means for mapping the storage units exported by the backend storage system 103 to the virtual storage units created on the in-band SAN virtualization storage node 201. In addition, the system includes means for, after the above operations are completed, canceling a third zone configuration including the host system 101 and backend storage system 103 in the first SAN-based storage system 100.

According to an embodiment of the present invention, the system further includes means for, after mapping the storage unit exported by the backend storage system 103 to the virtual storage unit created on the in-band SAN virtualization storage node 201, disabling the cache 221 of the in-band SAN virtualization storage node 201.

According an embodiment of the present invention, the system further includes means for, after canceling the third zone configuration including the host system 101 and backend storage system 103 in the first SAN-based storage system 100, enabling the cache 221 of the in-band SAN virtualization storage node 201.

According to an embodiment of the present invention, the system further includes means for, after mapping the storage unit exported by the backend storage system 103 to the virtual storage unit created on the in-band SAN virtualization storage node 201, informing the multi-path software 121 in the host system 101 to set a preferred path for transmitting the IO requests for the storage unit in the backend storage system 103.

According to an embodiment of the present invention, after mapping the storage unit exported by the backend storage system 103 to the virtual storage unit created on the in-band SAN virtualization storage node 201, the means for, informing the multi-path software 121 in the host system 101 to set a preferred path for transmitting the IO requests for the storage unit in the backend storage system 103 further includes means for informing the multi-path software 121 on the host system 101 about the identification of the virtual storage unit to which the storage unit in the backend storage system 103 corresponds; also includes means for discovering the connection path to the virtual storage unit by the multi-path software 121 on the host system according to the identification of the virtual storage unit; and includes means for setting the connection path to the virtual storage unit as a preferred path for transmitting IO requests for the storage unit in the backend storage system 103 by the multi-path software 121 in the host system 101.

According to an embodiment of the present invention, the virtual storage unit created on the in-band SAN virtualization storage node 201 has the same identification and capacity as the storage unit exported by the backend storage system 103.

According to an embodiment of the present invention, the system further includes means for mapping the virtual storage unit created on the in-band SAN virtualization storage node 201 to the host system 101.

According to an embodiment of the present invention, the operations of the above respective means are performed by an agent 211 provided on the in-band SAN virtualization storage node 201, an agent 111 provided on the host system 101, and the zone management module 112 in the FC switch network 102 of the first SAN-based storage system 100 in response to receiving commands transmitted by the migration manager 601 through the Ethernet.

Above is described the migration manager 601 for migrating a first SAN-based storage system 100 into an in-band SAN virtualization storage system 200 and the system for migrating a first SAN-bases storage system 100 into an in-band SAN virtualization storage system 200 according to embodiments of the present invention. It should be pointed out that, the above description is only exemplary, not limitation to the present invention. In other embodiments of the present invention, the migration manager and system can have more, less or different modules, and the relationships between the modules can be different from that is described. For example, the respective modules for migrating a first SAN-based storage system 100 into an in-band virtualized storage system 200 can be single modules, or can consist of a plurality of modules connected by networks.

The present invention can be realized in hardware, software, or a combination thereof. The present invention can be realized in a computer system in a centralized manner, or in a distributed manner, in which, different components are distributed in some interconnected computer systems. Any computer systems or other devices suitable for executing the method described herein are appropriate. A typical combination of hardware and software can be a computer system with a computer program, which when being loaded and executed, controls the computer system to execute the method of the present invention, and constitute the apparatus of the present invention.

The present invention can also be embodied in a computer program product, which can realize all the features of the method described herein, and when being loaded into a computer system, can execute the method.

Although the present invention has been illustrated and described with reference to the preferred embodiments, those skilled in the art will understand that various changes in form and details can be made thereto without departing from the spirit and scope of the present invention.

That which is claimed is:

1. A method of storage system migration, including migrating a first SAN-based storage system into an in-band SAN virtualization storage system without disrupting an existing connection path between a host system and a backend storage system in the first SAN-based storage system, the method comprising:
creating a first zone configuration including the host system in the first SAN-based storage system and an in-band SAN virtualization storage node in the in-band SAN virtualization storage system;
creating a second zone configuration including the backend storage system in the first SAN-based storage system and said in-band SAN virtualization storage node;
mapping a storage unit exported by the backend storage system to a virtual storage unit created on the in-band SAN virtualization storage node; and
canceling a third zone configuration including the host system and backend storage system in the first SAN-based storage system.

2. The method of claim 1, further comprising:
after mapping the storage unit exported by the backend storage system to the virtual storage unit created on the in-band SAN virtualization storage node, disabling a cache of the in-band SAN virtualization storage node.

3. The method of claim 2, further comprising:
after canceling the third zone configuration including the host system and backend storage system in the first SAN-based storage system, enabling the cache of the in-band SAN virtualization storage node.

4. The method of claim 1, further comprising:
after mapping the storage unit exported by the backend storage system to the virtual storage unit created on the in-band SAN virtualization storage node, informing multi-path software in the host system to set a preferred path for transmitting IO requests for the storage unit in the backend storage system.

5. The method of claim 4, wherein, said informing the multi-path software in the host system to set a preferred path for transmitting IO requests for the storage unit in the backend storage system, further comprises:
informing an identification of the virtual storage unit to which the storage unit in the backend storage system corresponds to the multi-path software in the host system;
discovering, by the multi-path software in the host system, a connection path to the virtual storage unit according to the identification of the virtual storage unit;
setting the discovered connection path to the virtual storage unit as a preferred path for transferring IO requests for the corresponding storage unit in the backend storage system by the multi-path software in the host system.

6. The method of claim 1, wherein the virtual storage unit created on the in-band SAN virtualization storage node has a same identification and capacity as the storage unit exported by the backend storage system.

7. The method of claim 1, further comprising:
mapping the virtual storage unit created on the in-band SAN virtualization storage node to the host system.

8. A system for storage system migration, for migrating a first SAN-based storage system into an in-band virtualization storage system without disrupting an existing connection path between a host system and a backend storage system in the first SAN-based storage system, the system comprising:
means for creating a first zone configuration including the host system in the first SAN-based storage system and an in-band SAN virtualization storage node in the in-band virtualization storage system;
means for creating a second zone configuration including the backend storage system in the first SAN-based storage system and the in-band SAN virtualization storage node;
means for mapping a storage unit exported by the backend storage system to a virtual storage unit created on the in-band SAN virtualization storage node; and
means for canceling a third zone configuration including the host system and backend storage system in the first SAN-based storage system.

9. The system of claim 8, further comprising:
means for, after mapping the storage unit exported by the backend storage system to the virtual storage unit created on the in-band SAN virtualization storage node, disabling a cache of the in-band SAN virtualization storage node.

10. The system of claim 9, further comprising:
means for, after canceling the third zone configuration including the host system and backend storage system in the first SAN-based storage system, enabling the cache of the in-band SAN virtualization storage node.

11. The system of claim 8, further comprising:
means for informing a multi-path software in the host system to set a preferred path for transmitting IO requests for the storage unit in the backend storage system after mapping the storage unit exported by the backend storage system to the virtual storage unit created on the in-band SAN virtualization storage node.

12. The system of claim 11, wherein said means for informing the multi-path software in the host system to set a preferred path for transmitting IO requests for the storage unit in the backend storage system after mapping the storage unit exported by the backend storage system to the virtual storage unit created on the in-band SAN virtualization storage node, further comprising:
means for informing an identification of the virtual storage unit to which the storage unit in the backend storage system corresponds to the multi-path software in the host system;
means for discovering a connection path to the virtual storage unit by the multi-path software in the host system according to the identification of the virtual storage unit;
means for setting the discovered connection path to the virtual storage unit as a preferred path for transmitting IO requests for the corresponding storage unit in the backend storage system by the multi-path software in the host system.

13. The system of claim 8, wherein the virtual storage unit created on the in-band SAN virtualization storage node has the same identification and capacity as the storage unit exported by the backend storage system.

14. The system of claim 8, further comprising:
means for mapping the virtual storage unit created on the in-band SAN virtualization storage node to the host system.

15. A migration manager of a storage system, for making a zone management module in an FC switch to migrate a first SAN-based storage system into an in-band SAN virtualization storage system without disrupting an existing connection path between a host system and a backend storage system in the first SAN-based storage system, the migration manager comprising:
means for creating a first zone configuration including a host system in the first SAN-based storage system and an in-band SAN virtualization storage node in the in-band SAN virtualization storage system and for creating a second zone configuration including a backend storage system in the first SAN-based storage system and the in-band SAN virtualization storage node, wherein in the in-band SAN virtualization storage node, a storage unit exported by the backend storage system is mapped to a virtual storage unit created on the in-band SAN virtualization storage node; and
means for making the zone management module in the FC switch to cancel a third zone configuration including the host system and backend storage system in the first SAN-based storage system.

16. The migration manager of claim 15, further comprising:
means for, after mapping the storage unit exported by the backend storage system to the virtual storage unit created on the in-band SAN virtualization storage node, making an agent in the in-band SAN virtualization storage node to disable a cache of the in-band SAN virtualization storage node.

17. The migration manager of claim 16, further including:
means for, after canceling the third zone configuration including the host system and backend storage system in the first SAN-based storage system, making the agent in the in-band SAN virtualization storage node to enable the cache in the in-band SAN virtualization storage node.

18. The migration manager of claim 15, further including:
means for, after mapping the storage unit exported by the backend storage system to the virtual storage unit created on the in-band SAN virtualization storage node, making the agent in the host system to inform a multi-path software in the host system to set a preferred path for transmitting IO requests for the storage unit in the backend storage system.

19. An article of manufacture tangibly embodying computer readable instructions which, when implemented, cause a computer to carry out the steps of a method according to claim 1.
